(19) United States
(12) Patent Application Publication
(10) Pub. No.: US 2023/0323732 A1
(43) Pub. Date: Oct. 12, 2023

(54) SAFETY CORD TILTER

(71) Applicant: Tser Wen CHOU, Yorba Linda, CA (US)

(72) Inventor: Tser Wen CHOU, Yorba Linda, CA (US)

(21) Appl. No.: 17/730,919

(22) Filed: Apr. 27, 2022

(30) Foreign Application Priority Data
Apr. 11, 2022 (TW) 111203617

(51) Int. Cl. E06B 9/326

(52) U.S. Cl. CPC E06B 9/326

(57) ABSTRACT

A safety cord tilter, in which two cords of the cord tilter for controlling opening or closing of the blind slats are exposed outside the headrail by a length set within a safety length range. The rear ends of the two cords are respectively connected with a first pull rod and a second pull rod for pulling the cords. When the first and second pull rods are used to control opening or closing of the blind slats, the first pull rod or the second pull rod reaches the blind rail at the top end, whereby the allowable exposed lengths of the pulled-out cords will not exceed the safety range so as to shorten the exposed length of the cords. This prevents a child from playing with the cords and twisting the cords around the neck and achieves safety effect.

### BACKGROUND OF THE INVENTION

### 1. Field of the Invention

The present invention relates generally to a safety cord tilter, and more particularly to a safety cord tilter, which can prevent a child from playing with the cords and twisting the cords around the neck.

### 2. Description of the Related Art

It is known that a conventional blind includes a cord tilter for moving the blind slats to open or close. Two cords are wound on a cord reel of the cord tilter to control the operation of the cord tilter. The cord reel is rotated clockwise or counterclockwise to drive a control rod. The two cord ends are suspended from the cord reel to the lower edge of a window. The two cords are not secured so that it's possible that a child playing with the cords and twisting the cords around the neck can cause fatal injury. Therefore, in use of the conventional blind, the suspending cords may lead to unexpected danger.

### SUMMARY OF THE INVENTION

It is therefore a primary object of the present invention to provide a safety cord tilter, which can effectively prevent a child from playing with the cords and enhance the safety effect. In the safety cord tilter, two cords of the cord tilter are exposed by a set length within a safety length range. In addition, the rear ends of the two cords are respectively and correspondingly connected with a first pull rod and a second pull rod. When the first pull rod or the second pull rod is used to pull the cords, it controls opening or closing of the blind slats. The first pull rod is pulled downward to make the second pull rod ascend and reach the blind rail at the top end, whereby the exposed length of the cord pulled out by the first pull rod still remains within the safety range. Therefore, a child is prevented from playing the cords so as to enhance safety of the blind.

To achieve the above and other objects, the safety cord tilter of the present invention includes a cord tilter main body and two cords wound on a cord reel of the cord tilter main body. The two cords suspend downward from the blind rail and the exposed length of the suspending cords is set within a safety range. The loose ends of the two cords are connected with a first pull rod and a second pull rod for pulling the cords. The set lengths of the first and second pull rods are determined by the height of the window. When using the first and second pull rods to pull the cords for controlling opening or closing the blind slats, the exposed length of the cords remains within the set safety length range. Therefore, a child is prevented from playing with the cords supplying needed safety.

The operation principle of the present invention is such that when the first pull rod is pulled downward, the second pull rod is lifted to the blind rail. At this time, the cord above the second pull rod is totally wound onto the cord reel and the blind slats are opened. The length of the cord above the first pull rod is equal to the length of the cord above the second pull rod so that the length of the cord remains within the safety range to ensure safety. Reversely, when the second pull rod is pulled downward, the first pull rod is lifted to the blind rail. At this time, the cord above the first pull rod is totally wound onto the cord reel and the blind slats are closed. The length of the cord above the second pull rod is equal to the length of the cord above the first pull rod so that the length of the cord remains within the safety range to ensure safety. In the case that the blind slats are controlled to half-open, the length of the cord above the first pull rod is equal to the length of the cord above the second pull rod so that the length of the cord remains within the safety range. Therefore, a child is prevented from playing with the cords and twisting the cords around the neck so as to enhance safety of the blind.

The core technique of the present invention is mainly that the first and second pull rods are used to control opening or closing of the blind slats so as to shorten the exposed lengths of the two pull cords and achieve maximum safety. Secondly, the first pull rod and the second pull rod, depending how the safety cord tilter is corded, can be used so that the blind slats can be moved to fully open, fully closed or half opened positions. In addition, the design of the lengths of the first and second pull rods is determined by the height of the window.

In order to solve the required extra cord beyond the safety range problem created by the wider 2.5″ and 3 slats″, the present invention alternatively includes a larger first sleeve and a second sleeve in the form of hollow structures. The two exposed cords suspending from the cord tilter are both conducted through the first and second sleeves. The top ends of the first and second sleeves are secured to the blind rail to remain in a stationary position. In addition, a thinner first pull tube and a second pull tube in the form of hollow structures are respectively fitted in the first and second sleeves. The two cords suspending from the cord tilter are conducted through the hollow structures of the first and second pull tubes to the rear ends thereof and secured with plugs, whereby the two cords are respectively connected with the first and second pull tubes. A user pulls the cords via the first and second pull tubes to control opening or closing of the blind slats. The two cords are secured to the rear ends of the first and second pull tubes so that extending distances of the first and second pull tubes are increased, whereby the exposed cords are totally concealed to enhance safety effect.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective view showing that the cords are passed through the pull rods and connected therewith;

FIG. 3 is a perspective assembled view of the present invention;

FIG. 4 is a perspective view of the present invention, showing that the blind slats are opened;

FIG. 5 is a plane view of the present invention, showing that the blind slats are opened;

FIG. 6 is a perspective view of the present invention, showing that the blind slats are closed;

FIG. 7 is a plane view of the present invention, showing that the blind slats are closed;

FIG. 8 is a perspective view of the present invention, showing that the blind slats are half-opened;

FIG. 9 is a plane view of the present invention, showing that the blind slats are half-opened;

FIG. 10 is a perspective exploded view of another embodiment of the present invention;

FIG. 11 is a perspective assembled view of the other embodiment of the present invention;

FIG. 12 is a perspective assembled view of the other embodiment of the present invention, showing that the cords are secured with the plugs;

FIG. 13 is a sectional assembled view of the other embodiment of the present invention;

FIG. 14 is a sectional assembled view of the other embodiment of the present invention, showing the operation thereof;

FIG. 15 is a perspective view of the other embodiment of the present invention, showing that the blind slats are opened;

FIG. 16 is a plane view of the other embodiment of the present invention, showing that the blind slats are opened;

FIG. 17 is a perspective view of the other embodiment of the present invention, showing that the blind slats are closed;

FIG. 18 is a plane view of the other embodiment of the present invention, showing that the blind slats are closed;

FIG. 19 is a perspective view of the other embodiment of the present invention, showing that the blind slats are half-opened; and

FIG. 20 is a plane view of the other embodiment of the present invention, showing that the blind slats are half-closed.

### DETAILED DESCRIPTION OF THE PREFERRED EMBODIMENTS

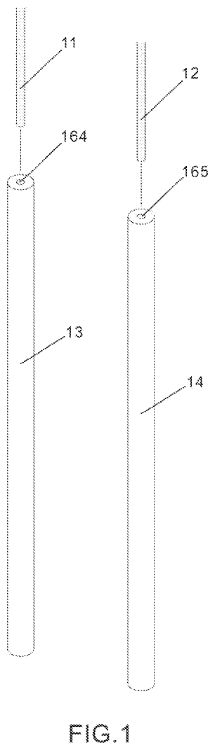

Please refer to FIGS. 1, 2, 3 and 4. The present invention mainly includes a cord tilter main body 1, two cords 11, 12 wound on a cord reel 10 of the cord tilter main body 1, a first pull rod 13 and a second pull rod 14 connected with rear ends of the two cords 11, 12. The cord tilter main body 1 is installed in a blind rail 15. The two cords 11, 12 on the cord reel 10 of the cord tilter main body 1 extend through the blind rail 15. The lengths of the two cords 11, 12 exposed to outer side of the blind rail 15 are set within a safety range.

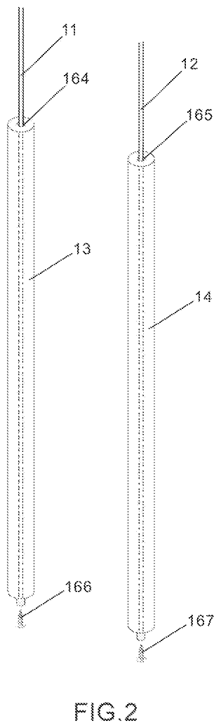

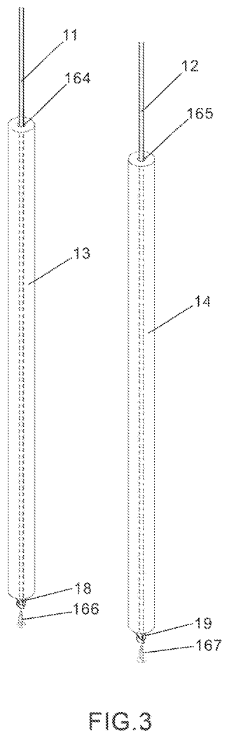

The rear ends of the cords 11, 12 are respectively connected with the first and second pull rods 13, 14. The first and second pull rods 13, 14 are respectively formed with passages 164, 165 between top faces and rear ends of the first and second pull rods 13, 14. The cords 11, 12 are conducted into the passages 164, 165 from the top faces of the first and second pull rods 13, 14 to downward extend to the rear ends of the first and second pull rods 13, 14 (as shown in FIG. 2). Then the cords 11, 12 are tied to form cord knots 18, 19 for securely connecting with the first and second pull rods 13, 14 (as shown in FIG. 3). Then the cord knots 18, 19 are plugged with plugs 166, 167, whereby the first and second pull rods 13, 14 and the two cords 11, 12 are connected with each other to form the safety cord tilter main body of the present invention. A user can pull the cords via the first pull rod 13 or the second pull rod 14 so as to control opening or closing of the blind slats.

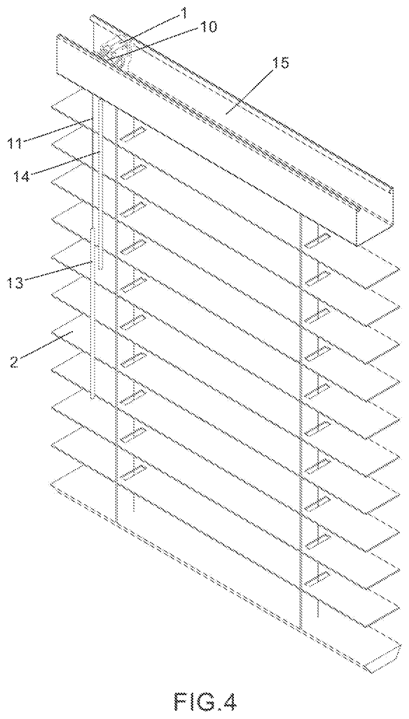

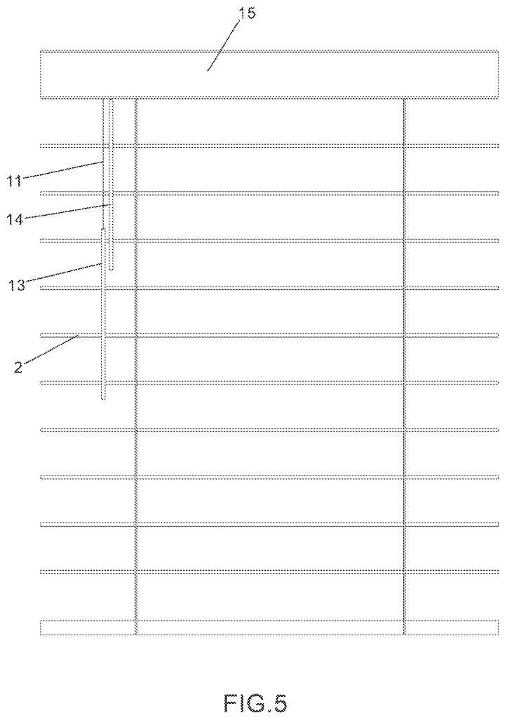

When it is desired to control the blind slats to open (with reference to FIGS. 4 and 5), the first pull rod 13 is downward pulled to drive the cord 11 to operate. The cord 11 of the cord reel 10 is pulled out of the blind rail 15 by a length exposed to outer side. Also, the cord reel 10 of the cord tilter main body 1 is driven to counterclockwise rotate to drive and open the slats 2. At the same time, the second pull rod 14 is upward driven by the cord reel 10 to shorten the length of the cord 11 until reaching the blind rail 15. At this time, the first pull rod 13 cannot be further pulled and the blind slats 2 are controlled by a control rod and opened. Under such circumstance, the exposed length of the cord 11 is within a safety range. The lengths of the first and second pull rods 13, 14 are determined by the height of the window.

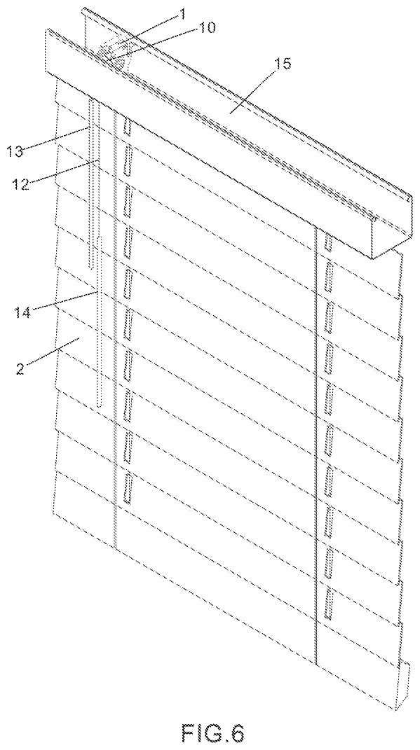

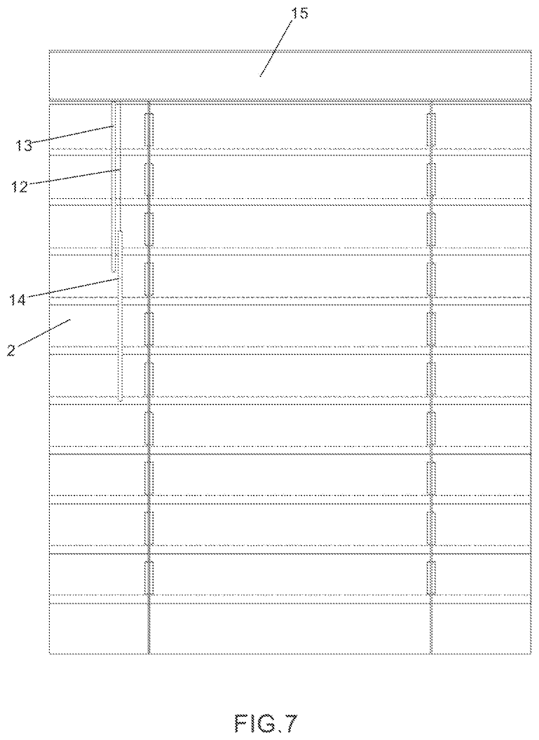

When it is desired to control and close the blind slats 2 (with reference to FIGS. 6 and 7), the second pul 1 rod 14 is downward pulled to drive the cord 12 to operate. The cord 12 on the cord reel 10 is pulled out by a length exposed to outer side. Also, the cord reel 10 of the cord tilter main body 1 is driven to clockwise rotate to drive and close the slats 2. At the same time, the first pull rod 13 is upward driven by the cord reel 10 to shorten the length of the cord 12 until reaching the blind rail 15. At this time, the second pull rod 14 cannot be further pulled and the blind slats 2 are controlled by the control rod and closed. Under such circumstance, the exposed length of the cord 12 is within a safety range.

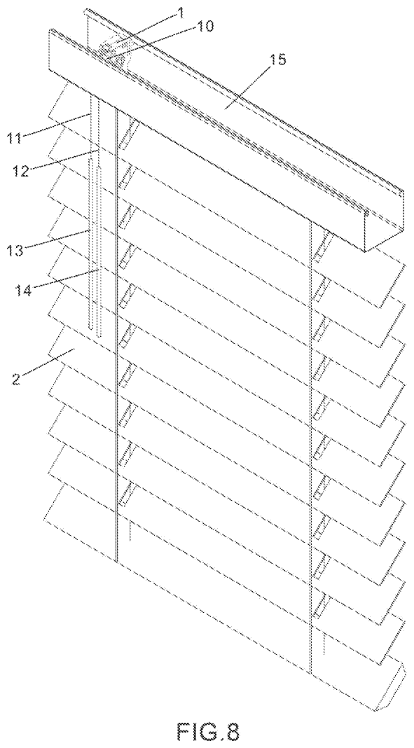

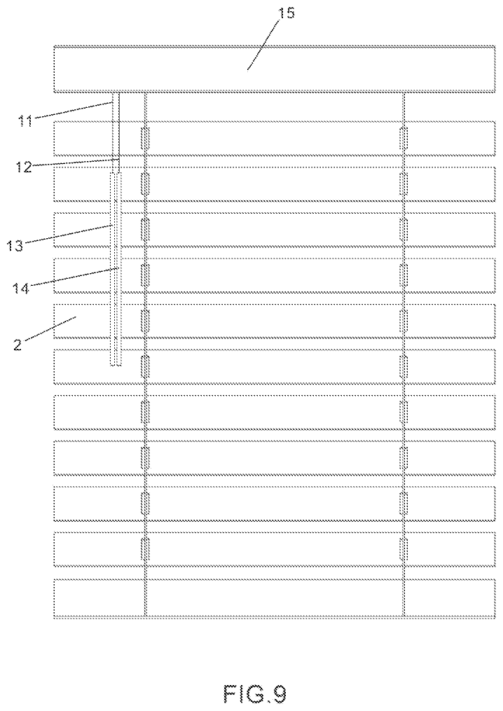

Please refer to FIGS. 8 and 9. When it is desired to half-open the blind slats 2, the first pull rod 13 or the second pull rod 14 is downward pulled. When the first and second pull rods 13, 14 are pulled to the same height, the user stops pulling the first pull rod 13 or the second pull rod 14. At this time, the blind slats 2 are situated in a half-opened state and the exposed lengths of both the cords 11, 12 are within the safety range.

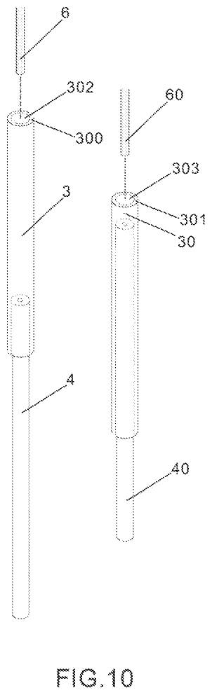

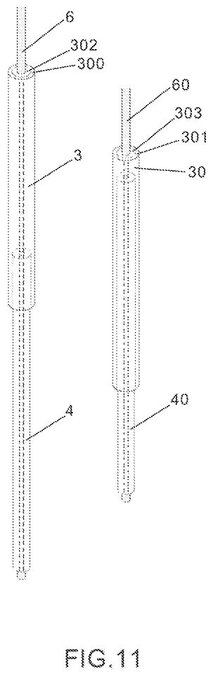

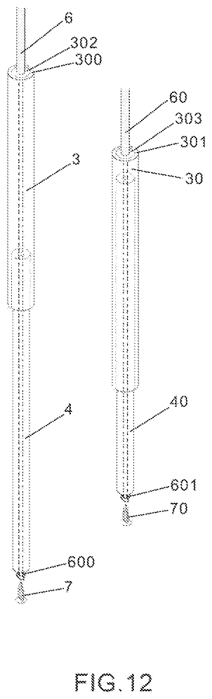

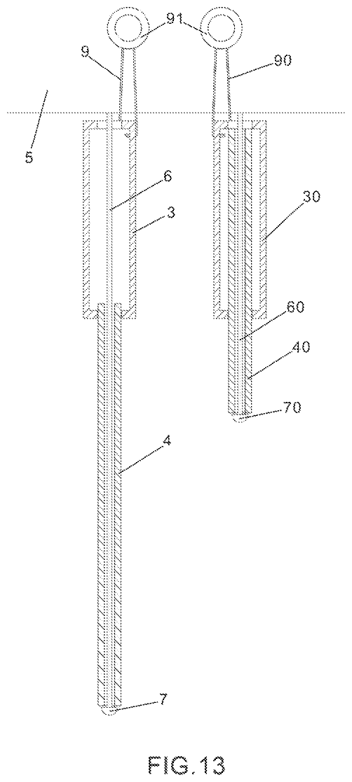

Please refer to FIGS. 10 to 13, which show another embodiment of the present invention for solving the extra required cord beyond the safety length problem created by the width of 2.5″ and 3″ blind slats. According to this embodiment, the present invention mainly includes a first sleeve 3, a second sleeve 30 and a first pull tube 4 and a second pull tube 40 fitted in the first and second sleeves 3, 30. The first and second sleeves 3, 30 are hollow structures. The top ends of the first and second sleeves 3, 30 have closed end faces 300, 301. The closed end faces 300, 301 are respectively formed with perforations 302, 303. The first and second pull tubes 4, 40 are hollow structures. The first and second pull tubes 4, 40 are telescopically fitted in the first and second sleeves 3, 30. When assembled, two cords 6, 60 suspending from the cord tilter are respectively conducted through the perforations 302, 303 of the closed end faces 300, 301 of the first and second sleeves 3, 30 and through the first and second pull tubes 4, 40 to the rear end of the first pull tube 4 or the second pull tube 40. Then the cords 6, 60 are tied to form cord knots 600, 601 (as shown in FIGS. 11 and 12). Then the cord knots 600, 601 are secured with plugs 7, 70. Then cord knots 600, 601 are burnt to form knot balls so as to connect the two cords 6, 60 with the first and second pull tubes 4, 40. Then the first and second sleeves 3, 30 are made secured and stationary by means of hanging strings 9, 90 hung on a screw 91 secured on the blind rail 5 (as shown in FIG. 13). Accordingly, by means of pulling the first pull tube 4 and the second pull tube 40, the blind slats 2 can be controlled and driven to open or close.

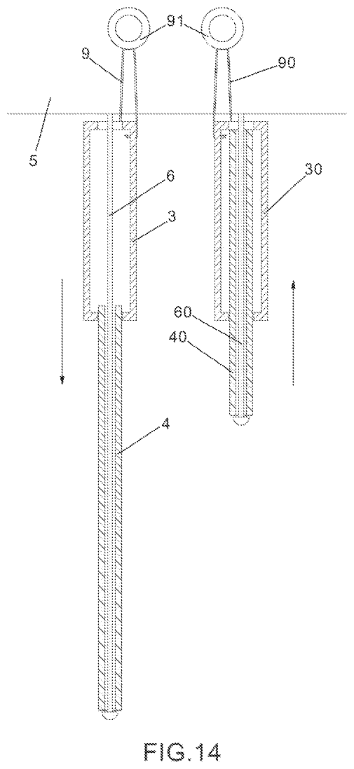

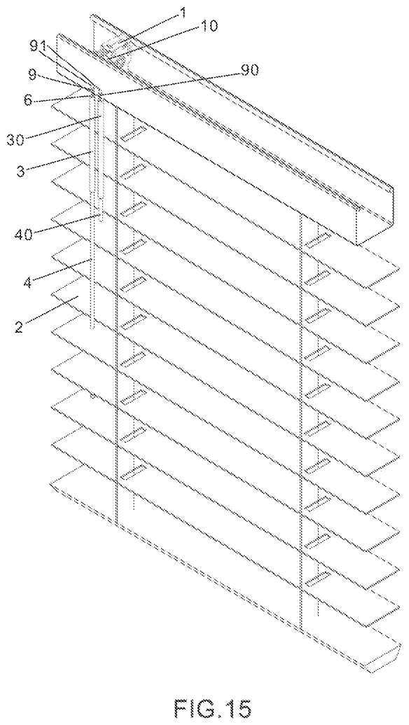

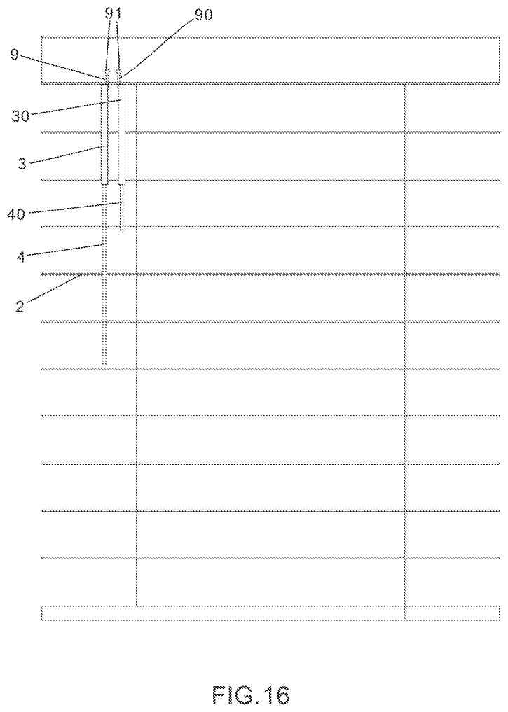

When it is desired to control the blind slats to open (with reference to FIGS. 14, 15 and 16), the first pull tube 4 is downward pulled to drive the cord 6 to operate. The cord 6 of the cord reel 10 is driven into the first sleeve 3 and concealed. Also, the cord reel 10 of the cord tilter main body 1 is driven to counterclockwise rotate to drive and open the slats 2. At the same time, the second pull tube 40 and the cord 60 are upward driven by the cord reel 10 and retracted into second stationary sleeve 30 until reaching the inner side of the top end of the second sleeve 30. At this time, the first pull tube 4 cannot be further pulled and the blind slats 2 are controlled by the control rod and opened. Under such circumstance, the cords 6, 60 are totally concealed within a safety range without being exposed. Also, the beauty of the appearance of the blind is enhanced.

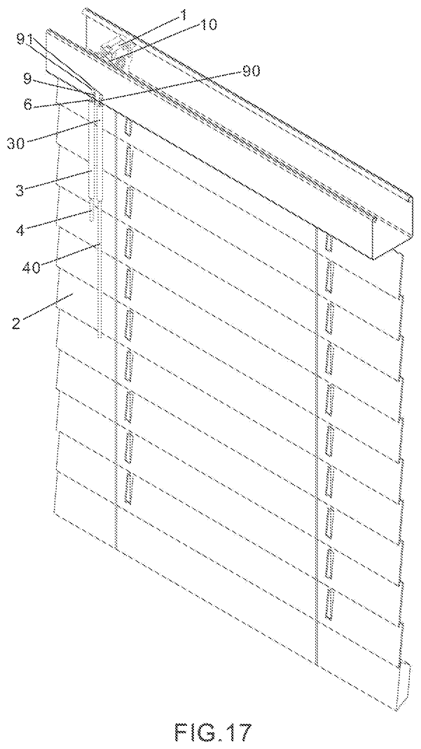

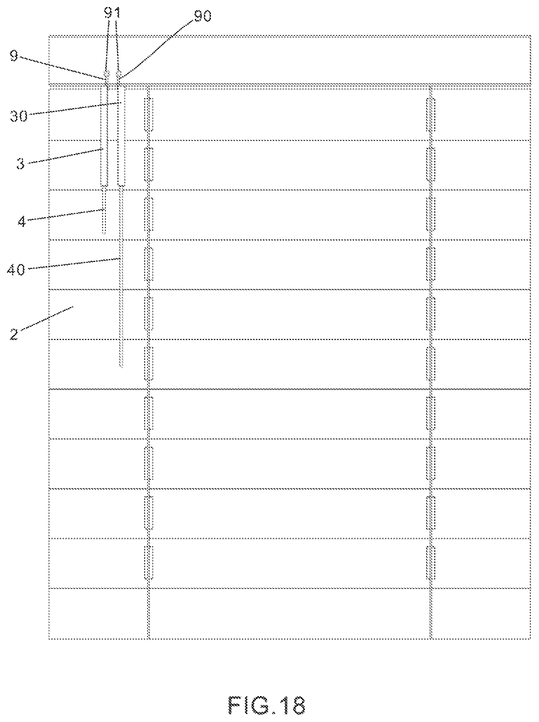

When it is desired to control and close the blind slats 2 (with reference to FIGS. 17 and 18), the second pull tube 40 is downward pulled to drive the cord 60 to operate. The cord 60 of the cord reel 10 is moved within the second sleeve 40 and concealed by a concealed length. Also, the cord reel 10 of the cord tilter main body 1 is driven to clockwise rotate to drive and close the slats 2. At the same time, the first pull tube 4 is upward driven by the cord reel 10 to retract into the first sleeve 3 until reaching the inner side of the top end of the first sleeve 3. At this time, the second pull tube 40 cannot be further pulled and the blind slats 2 are controlled by the control rod and closed. Under such circumstance, the cords 6, 60 are totally concealed within a safety range without being exposed.

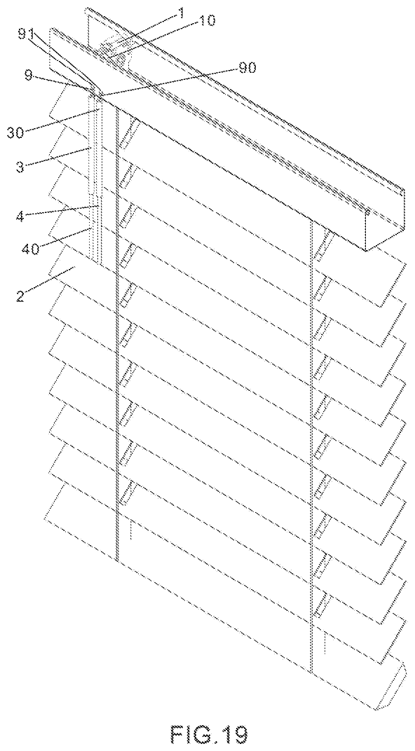

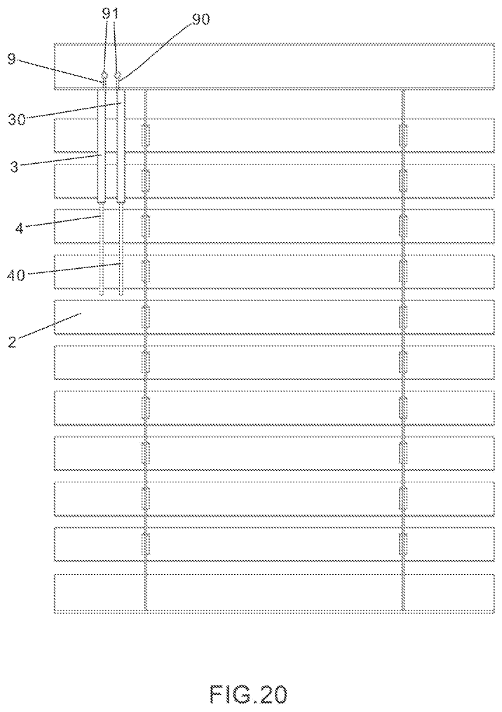

Please refer to FIGS. 19 and 20. When it is desired to half-open the blind slats 2, the first pull tube 4 or the second pull tube 40 is downward pulled. When the first and second pull tubes 4 and 40 are pulled to the same height, the user stops pulling the first pull tube 4 or the second pull tube 40. At this time, the blind slats 2 are situated in a half-opened state and both the cords 6, 60 are concealed without being exposed to outer side so as to achieve the object of safety.

The above embodiments are only used to illustrate the present invention, not intended to limit the scope thereof. Many modifications of the above embodiments can be made without departing from the spirit of the present invention.

What is claimed is:

1. A safety cord tilter comprising:
a cord tilter main body disposed in a blind rail; a cord reel being disposed beside the cord tilter main body;
two cords respectively secured to two ends of a reel face of the cord reel, the two cords being respectively wound on two sides of the cord reel to downward suspend from the cord reel and pass through the blind rail, the two cords being exposed to outer side of the blind rail by a safety length; and
two pull rods, which are elongated hollow rod bodies, top ends of the two pull rods having closed faces, each of the closed faces being formed with a perforation, the two cords being conducted through the perforations to downward extend to rear ends of the two pull rods and connect therewith, when the first and second pull rods are used to control opening and closing of the blind slats, the first pull rod being downward pulled to make the second pull rod ascend and reach the blind rail, whereby the exposed lengths of the pulled out cords are still within a safety range so as to prevent a child from playing the cords and twisting the cords around the neck and achieve safety effect.

2. The safety cord tilter as claimed in claim 1, wherein the specific safety range of the lengths of the cords is set 8 inches or smaller than 8 inches.

3. The safety cord tilter as claimed in claim 1, wherein the two pull rods have a length equal to or larger than or over twice the lengths of the cords, the length of the two pull rods being determined by a height of a window.

4. The safety cord tilter as claimed in claim 1, wherein plugs are further disposed at rear ends of the two pull rods for securing the cords.

5. A safety cord tilter comprising:
a cord tilter main body disposed in a blind rail; a cord reel being disposed beside the cord tilter main body;
two cords respectively secured to two ends of a reel face of the cord reel, the two cords being respectively wound on two sides of the cord reel to downward suspend from the cord reel and pass through the blind rail into two sleeves;
two sleeves including a first sleeve and a second sleeve, the first and second sleeves being hollow structures, the top ends of the first and second sleeves being secured and stationary to lower edge of the blind rail; and
two pull tubes including a first pull tube and a second pull tube, the first and second pull tubes being hollow structures, the first and second pull tubes being respectively telescopically fitted in the first and second sleeves, the two cords being respectively conducted through the first and second pull tubes to the rear ends of the first and second pull tubes and securely connected therewith, when the first and second pull tubes are used to control opening and closing of the blind slats, the pulled out cords being concealed in the first and second stationary sleeves to increase the extending length of the cords, whereby the cords are prevented from being exposed to enhance safety.

6. The safety cord tilter as claimed in claim 5, further comprising a string loop disposed on top edges of the first and second stationary sleeves for hanging the first and second sleeves.
